(19) United States
(12) Patent Application Publication
(10) Pub. No.: US 2004/0158597 A1
(43) Pub. Date: Aug. 12, 2004

(54) Method and apparatus for constructing efficient elliptic curve cryptosystems

(76) Inventors: Ding Feng Ye, Beijing (CN); Feng Bao, Singapore (CN); Hui Jie Robert Deng, Singapore (CN); Hong Jun Wu, Singapore (CN)

Correspondence Address: KNOBBE MARTENS OLSON & BEAR LLP, 2040 MAIN STREET, FOURTEENTH FLOOR, IRVINE, CA, 92614, US

(21) Appl. No.: 10/474,152

(22) PCT Filed: Apr. 5, 2001
(86) PCT No.: PCT/SG01/00077

(51) Int. Cl. G06F 7/00

(52) U.S. Cl. 708/492

(57) ABSTRACT

Methods and apparatus to construct finite fields over which efficient elliptic curve cryptosystems can be set up. Given a security parameter k, the said methods and apparatus consist of devices for carrying out operations in a small k₀-bit field k₀ and methods to successively build extension fields K₁; K₂, . . . , Kₜ, where the extension K₁/K₀ has degree 2 or 3 and the other extensions Kᵢ/K_{I-1}, are quadratic, Kₜ is the final field over which elliptic curves are defined, and Kₜ has size kₒ2^{t} or 3k₀2^{t-1} just exceeding the said security parameter k.

### FIELD OF THE INVENTION

The present invention relates to the field of implementing elliptic curve cryptosystems, and particularly to methods and apparatus for efficient implementation thereof. In this regard the present invention may be applied to information and document security systems using public key encryption technology, including systems where such operations are performed by low cost low power computing devices.

### BACKGROUND

With the increasing implementation of electronic communication more and more information is stored in electronic form. This form of storage is more efficient and space-saving as compared with paper documents, but electronic information is also subject to different, and potentially damaging, security issues. That is, electronic information is more prone to unauthorised disclosure, alteration, substitution and destruction.

A number of approaches have been developed to address these problems, one being cryptography. Cryptography transforms electronic data to a modified form and the transformation is controlled by the use of a key or keys, which takes the form of an electronic string.

One type of encryption is public-key encryption, where both the originator of the information and the recipient have different keys, being private and public keys respectively. Various types of public key cryptographic systems have been developed, including elliptic curve cryptography.

The security of an elliptic curve cryptosystem (ECC) is measured by the largest prime factor of the curve order, which is in practice approximate to the field order. The finite field order is the number of elements it contains. Therefore the field size in bits is usually taken as the security parameter of an ECC. Currently, 160 bit is regarded as the lower bound for the field size used in ECCs.

An ECC typically uses an elliptic curve as the group acting the role of GF(p) as in traditional Deffe-Hellman and EIGamal schemes. An ECC over a finite field requires arithmetic operations of addition, multiplication, squaring and inversion. Additionally, subtraction and modular arithmetic operations may also be required.

An elliptic curve is defined over a finite field K, and can have either affine or projective representation. The group operation on an elliptic curve is formulated in operations in the underlying finite field. In affine representation, one curve operation (point addition or doubling) needs a few field multiplications and one inversion, while in projective representation, one curve operation needs many more multiplications but no inversion. The cost ratio of multiplication/inversion is the main concern on choice between affine or projective representation, and the cross-point is around 7.

While various ECC methods have been developed, in general the technology is either not sufficient in performance, or the hardware required for implementation is too expensive.

There is therefore the need for a more efficient ECC method, particularly a method that does not require costly hardware for implementation.

The main task for building an efficient ECC is to construct a finite field of size exceeding the security parameter and with efficient field operations.

In this regard, the two main types of field constructions for ECC are GF(p) and GF(2ⁿ) in polynomial basis. These constructions have reasonable performance for desktop applications. For GF(p), inversion is very slow, and projective representation must be used. For GF(2ⁿ), multiplication is slower than that for GF(p). This is due to the fact that multiplication of binary polynomials has to be implemented completely in software while integer multiplication can utilize the built in instruction for multiplication of two word-size integers. Inversion in GF(2ⁿ) is implemented using extended Euclidean division. Although GF(2ⁿ) with polynomial basis has reasonable performance on desktop computers, both multiplication and inversion have complexity O(n²).

One method for implementing ECCs for desktop computers uses Optimal Extension Fields (OEF) [D. V. Bailey and C. Paar, “Optimal Extension Fields for Fast Arithmetic in Public-Key Algorithms”, Proceedings of Advances in Cryptology—Crypto'98, pp. 472-485, Springer Verlag, 1998]. There are two types of OEFs. Type I OEF is defined as GF(p^{m}) with irreducible polynomial X^{m}−w for some small integer w where p=+2ⁿ±1 is a Fermat or Mersene prime. Type II OEF is defined as GF(p^{m}) with irreducible polynomial X^{m}−2 where p=2ⁿ−c; [c]<n/2 is a pseudo-Mersene prime. The multiplication in an OEF can make use of Karatsuba-Ofman technique to improve efficiency. There are 3 approaches to implement the inversion in an OEF. The first one is to compute the inverse of an element as raising it to a power of q−1, however it needs a lot of field multiplications. The second one uses a modified almost inverse algorithm [E. J. Lee, D. S. Kim, and P. J. Lee, Speed up of GF(p^{m}) Arithmetic For Elliptic Curve Cryptosystems. Proceedings of ICICS'98, Berlin, 1998. Springer Lecture Notes in Computer Science], however it needs about 3n² multiplications in GF(p). A third method [T. Kobayashi, H. Morita, K. Kobayashi, and F. Hoshino. Fast Elliptic Curve Algorithm Combining Frobenius Map and Table Reference to Adapt to Higher Characteristic. Advances in Cryptography-EUROCRYPT'99. Springer-Verlag, 1999] uses linear transformations which is only efficient for m<4. With these methods, the inversion in OEF is still relatively slow compared with multiplication.

Therefore it is apparent that in many ECC methods, the inversion operation is a bottleneck of ECC performance.

There is therefore a need for a more efficient mechanism for effecting inversion operations as well as optimizing other basic operations.

There are various hardware implementations of finite field operations such as described in U.S. Pat. Nos. 5,612,910, 5,768,168 and 6,003,057. The drawback of these implementations, however, is that such circuits are too large and hence too expensive for a typical ECC application.

There is therefore a need for an improved apparatus and/or method for improving the efficiency of field operations in ECCs.

The present invention seeks to overcome or at least ameliorate at least one of the problems of the prior art.

### SUMMARY OF THE INVENTION

In a first aspect the present invention provides a method of implementing elliptic curve cryptography including performing arithmetic operations over a field Kₒ; and using a result of the arithmetic operations over the field to perform arithmetic operations in one or more extension fields.

According to another aspect, the present invention provides a method of electronically converting an electronic message to an encrypted message for transmission over a transmission medium, said method comprising the steps of: using an ECC to perform arithmetic operations on a private key and a point, wherein said point is a point on an elliptic curve over a finite field Kₒ; using a result of the arithmetic operations over the field to perform arithmetic operations in one or more extension fields Kⱼ, based upon the operations in the previous field Kⱼ₋₁, in order to determine an enciphering key; using an encryption/decryption means to convert said electronic message to said encrypted message using said enciphering key; and using a transmitting means to transmit said encrypted message over said transmission medium.

According to a further aspect, the present invention provides a computer program product including a computer usable medium having computer readable program code and computer readable system code embodied on said medium for implementing elliptic curve cryptography within a data processing system, said computer program product further including computer readable code within said computer usable medium for constructing a finite field Kₒ, such that the size of the field exceeds a security parameter k; and performing arithmetic operations in Kₒ and in at least one subsequent extension field Kⱼ, based upon the operations in the previous field Kⱼ₋₁.

According to a still further aspect, the present invention provides a function module for performing large finite field operations comprising: (a) a plurality of devices for carrying out arithmetic operations in a field K₀, being from the following group:

i) One or more K₀-adders for performing additions and/or subtractions in K₀.

ii) One or more K₀-multipliers for performing multiplications in K₀.

iii) One or more Koinverters for performing inversions in K₀.

(b) Logic means for utilizing the devices in (a) to iteratively form one or more multipliers and/or inverters in one or more extension fields K₁ in order to carry out arithmetic operations in the one or more extension fields.

The essence of the present invention ties in the features of utilizing the operators in the underlying finite field for an ECC that is built up recursively by a series of smaller and smaller sub-sub-field operations. The present invention is based upon the realisation that an operation in Kₙ can be factorised into a plurality of operations in K₀ which are more efficient.

In this way, the arithmetic operations are simplified and hence the efficiency improved. Also, for hardware implementations, only operations in the base field need be circuit integrated, and subsequent field iterations can all be implemented using this hardware in combination with additional programming logic. This therefore greatly reduces the size and cost of the hardware.

### BRIEF DESCRIPTION OF THE DRAWINGS

A preferred embodiment of the present invention will now be described, by way of example only, with reference to the accompanying drawings in which:

FIG. 1 which illustrated a flow chart of iterative arithmetic operations in a plurality of expansion fields Kⱼ according to an embodiment of the invention.

FIG. 2 illustrates a flow chart of a method of encrypting a message for transmission according to an embodiment of the invention.

### DETAILED DESCRIPTION

The efficiency of field operation implementation generally depends on he hardware. In ECC applications, there are three standard types of hardware: powerful general-purpose processors for desktop computers, microprocessor for digital devices such as smart cards and hand-phones, and specialized circuits. For these different types of hardware, the most efficient choice of field construction will differ.

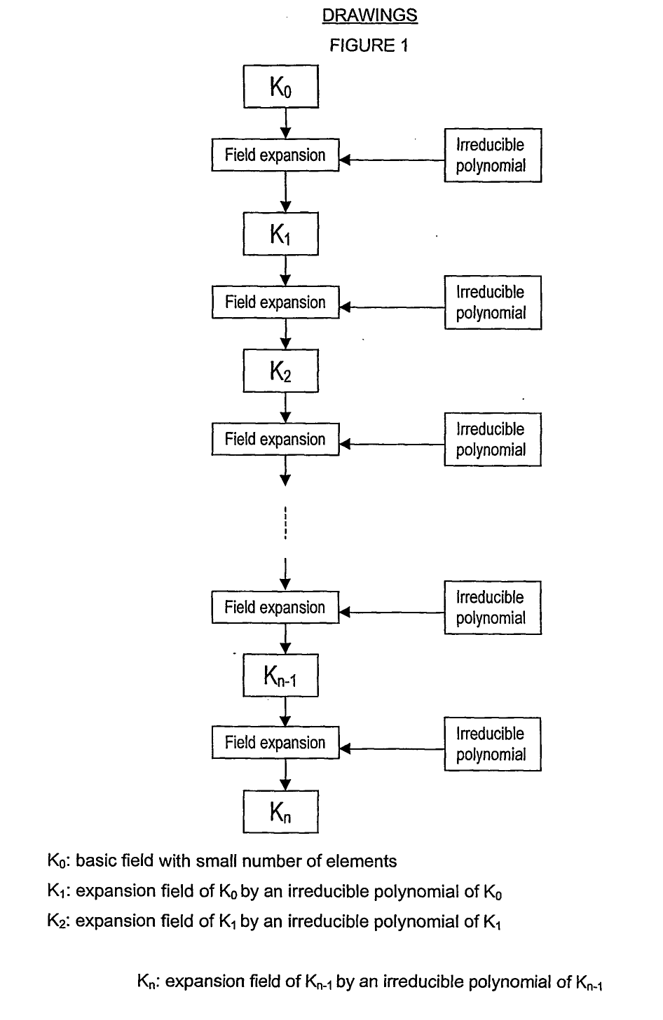

In this regard, a first embodiment of the present invention will not be described with reference to FIG. 1:

Let K be any finite field. An extension K⁽ⁿ⁾ of K is defined by an irreducible polynomial P(X) of degree n over K. Elements of K⁽ⁿ⁾ are polynomials of degree <n. Addition in K⁽ⁿ⁾ is just addition of polynomials. Multiplication in K⁽ⁿ⁾ is defined to be multiplication of polynomials mod P(X). Inversion of A(X) is define to be the polynomial B(X) such that A(x)B(X)=mod P(X).

The multiplication in K⁽ⁿ⁾ is carried out in two steps. The first step is multiplication of polynomials. In this regard, the following algorithms may be used for this step:

Multiplication of Polynomials of Degree 1

Input: A(X)=a₀+a₁X;B(X)=b₀+b₁X.

Output: C(X)=A(X)B(X)=c₀+c₁X+c₂X².

Begin

c₀=a₀b₀;c₂=a₁b₁;c₁=(a₀+a₁)(b₀+b₁)−c₀−c₂;

End

Multiplication of Polynomials of Degree 2

Input: A(X)=a₀+a₁X+a₂X²;B(X)=b₀+b₁X+b₂X².

Output: C(X)=A(X)B(X)=c₀+c₁X+c₂X²+c3X³+c₄X⁴.

Begin

m₀=(a₀+a₁)(b₀+b₁);m₁=(a₁+a₂)(b₁+b₂);m₂=(a₀+a₂)(b₀+b2);m₃=a₁b₁;

c₀=a₀b₀;c₁=m₀−c₀−m₃;c₄=a₂b₂;

c₃=m₁−m₃−c₄;c₂=m₂+m₃−c₀−c₄;

End

Note: In above formulae, addition and subtraction is the same as X or when characteristic is 2.

The second step multiplication in K⁽ⁿ⁾ is reduction mod P(X). The complexity of this step depends on the choice of P(X). The choices of P(X) and corresponding implementation of this step is illustrated in the following subsections.

The inversion in K⁽ⁿ⁾ can in general be implemented by the modified extended Euclid algorithm which needs an inversion in K and about 3n² multiplications in K. Another method to invert A(X) is solving the linear equation A(X)B(X)=1 mod P(X) where B(X) is regarded as the unknown and multiplication by A(X) is regarded as a linear transformation on K⁽ⁿ⁾. When n=2, both the two methods result in the same algorithm as follows:

Inversion Algorithm in Extension Field of Degree 2

Assume P(X)=X²+bX+a.

Input: A(X)=a₀+a₁XεK⁽²⁾.

Output: B(X)=b₀+b₁X=A(X)⁻¹εK⁽²⁾.

Begin

r=ba₁−a₀;s=ra₀+aa₁²;t=s⁻¹;

b₀=tr;b₁=ta₁;

End

When P(X) has simple coefficients a, b, this algorithm requires three multiplications and one squaring and one inversion in K. For odd characteristic, this is roughly 4 multiplications and 1 inversion; and for even fields it is little more than three multiplications and one inversion, since squaring is much cheaper in this case.

When n=3, solving a linear equation is a preferred approach, which results in the following algorithm:

Inversion Algorithm in Extension Field of Degree 3

Assume P(X)=X³+cX²+bX+a.

Input: A(X)=a₀+a₁X+a₂X²εK⁽³⁾.

Output: B(X)=b₀+b₁X+b₂X²=A(X)⁻¹εK⁽³⁾

```
Begin
    r₁ = a₀ − ba₂; r₂ = a₁ − ca₂; s₁ = −(aa₂ + br₂); s₂ = r1 − cr₂;
    r = r₁s₂ − r₂s₁;
    if r = 0 {
        s = (aa₂s₁ − ar₂r₁)⁻¹; b₀ = 0; b₁ = −ss₁; b₂ = sr₁;
            }
    else {
        s = a₁s₂ − a₂r₂; t = a₂r₁ − a₁s₁; u = −(ra₀ + asa₂ + atr₂)⁻¹;
                b₀ = −ur; b₁ = us; b₂ = ut;
            }
End
```

When P(X) has simple coefficients a, b, c, this algorithm requires no more than twelve multiplications and one inversion in K.

In the next subsections, we will illustrate how to select the irreducible polynomial for each extension step.

Selecting Irreducible Polynomials: Case of Characteristic 2

Assume K₀=GF(2ⁿ). If in the first extension step K₁/K₀, the extension degree is 3 and n is prime to 3, then let the irreducible polynomial be P(X)=X³+X+1; if 3|n the simplest P(X) depends on the details of the said K₀-multiplier and can be determined by computer searching. Now we can let K₁ play the role of K₀ in the subsequent extension steps. So we may assume all extensions starting from K₀=GF(2ⁿ) are of degree 2.

If n is odd, we can let P₀(X)=X²+X+1 in the first extension step k₁/K₀ and let x₁ be a root of P₀(X) in K₁. Then P₁(X)=X²+x₁X+1 is irreducible over K₁ and we can let it define the extension K₂/k₁. In general, let xⱼ be a root of Pⱼ₋₁(X) in Kⱼ, then Pⱼ(X)=X²+xⱼX+1 is irreducible over Kⱼ and we can let it define the extension Kⱼ₊₁/Kⱼ.

If n=2^{k}n′ with n′ odd, then GF(2ⁿ) contains an element y₀ which is algebraically equivalent to xₖ defined above. Now let the above P₀(X) be replaced by X²+y₀X+1, then the statements run the same as above.

When the irreducible polynomials are chosen as above, the operations in Kⱼ can be formulated based on those in Kⱼ−1 as follows. Denote an element a+bxⱼεKⱼ as (a, b), and consider 4 kinds of operations in Kⱼ:

1. Multiplication-by-xj:

(a;b)xⱼ=(b,a+bxⱼ₋₁)

It needs one addition (XOR) plus one multiplication-by-xⱼ₋₁ in Kⱼ₋₁. By recursive induction, this finally reduces to 2^{j}−1 additions and one multiplication-by-x₀ in K₀.

2. Squaring:

(a,b)²=((a+b)²;b²xⱼ₋₁)

It needs one addition (XOR) plus one multiplication-by-xⱼ₋₁ and 2 squaring in Kⱼ₋₁. By recursive induction, this finally reduces to <j2ⁱ additions, j+1)j/2 multiplication-by-x₀ and 2^{j} squarings in K₀.

3. Multiplication:

(a,b)(c,d)=(ac+bd,ad+bc+bdxⱼ₋₁)

It can be done by 3 multiplications (ac, bd, (a+b)(c+d)), 5 additions and one multiplication-by-xⱼ₋₁ in Kⱼ₋₁, and finally reduces to 3^{j} multiplications, Σ_{i<j}6*2^{j-i-1}*3ⁱ=6(3ⁱ−2ⁱ) additions and <0:5×3^{j} multiplications-by-x₀.

4. Inversion:

(a,b)⁻¹=(a²+b²+abxⱼ₋₁)⁻¹(a+bxⱼ₋₁,b)

It can be done by 3 multiplications, one inversion and one squaring, 2 additions (a²+b²+xⱼ₋₁ab=b²+a(a+bxⱼ₋₁)), and one multiplication-by-xⱼ₋₁ in Kⱼ₋₁; and finally reduces to 1:5×3^{j} multiplications, Σ_{i<j}2ⁱ<2ⁱ squarings, Σ_{0<i<j}(i2ⁱ+18(3ⁱ−2)+3*2ⁱ)<9×3^{j}−(15−2j)2ⁱ⁺¹⁵ additions, <j+2^{j}1+3^{j} multiplications-by-x₀, and one inversion in K₀.

Note that if K₀=GF(2ⁿ) with n odd, then x₀=1 and all multiplications-by-x₀ above are not needed. It can be seen that an inversion costs only about 1.5 multiplications.

Selecting Irreducible Polynomials: Case of Odd Characteristic

Suppose K₀=GF(p) is a k₀ bit field and k is the security parameter. Let m be the smallest positive integer of the form 3×2^{j-1} or 2^{j} such that m×k₀>k. If there exists a binomial irreducible polynomial X^{m}−w over K₀, then the irreducible polynomial in each extension step can be chosen as follows:

For the first step K₁/K₀, let P₀(X)=X³−w or P₀(X)=X²−w; for subsequent steps let Pᵢ(X)=X²−xᵢ, where xᵢ is a solution of the previous Pᵢ₋₁ in Kᵢ. The multiplication-by-xᵢ can be formulated as (a,b)xᵢ=(bxᵢ₋₁, a), where x₀=w and if K₁/K₀ is of degree 3, then (a,b,c)x₁=(cw, a, b). So it can be finally reduced to a single multiplication-by-w in GF(p). The condition for the existence of such irreducible X^{m}−w in GF(p) is as follows:

1. If 3|m and j=2, then 3|p−1.

2. If 3|m and j>2, then 12|p−1.

3. If 3|m and j>=2, then 4|p−1.

When the condition is satisfied, w can be chosen as a primitive root of p.

When irreducible X_{w}^{m} as above does not exist, the irreducible polynomials can be chosen as follows. If 3|m, we can let P₀(X) be any irreducible polynomial of degree 3 with simple coefficients. For example, if 3|p−1, we can search a wΣGF(p) with lowest hamming weight such that P₀(X)=X³−w is irreducible; otherwise, we can search irreducible polynomials of the form X³−X−w where w has lowest hamming weight. Since the subsequent irreducible polynomials are irrelevant to the choice of the first degree 3 extension, we can assume m=2^{j} in the following when considering successive quadratic extensions.

If p=1 mod 4, we can choose a quadratic non-residue w with lowest hamming weight, and let P₀(X)=X²−w, and let Pᵢ(X)=X²−xᵢ where xᵢ is a solution of Pᵢ₋₁ similar as above.

If p=3 mod 4, we can let P₀(X)=X²+1 choose an element of the form x₁=x₀+wεK₁ such that P₁(X)=X²−x₁ is irreducible, where x₀ is a root of P₀ and wεGF(p) has lowest hamming weight. The subsequent Pᵢ can be defined in the same way as above. In this case, a multiplication-by-xⱼ can be reduced to a multiplication-by-x₁ which is two additions and two multiplications-by-w in GF(p). Performance

The performance of an ECC system depends both on the field construction and on the hardware. In a typical application context, a suitable choice of sub-field K₀ followed by a single step field extension, which is known as OEF or “sub-field method”, generally offers better performance than the traditional GF(p) and GF(2ⁿ) method. Compared to the “sub-field method”, the current invention gives the same efficient multiplication but faster inversion and hence gives additional performance improvement. This improvement is illustrated by the examples in the following section.

### EXAMPLES

In the following examples, we assume the security parameter is 160 bits.

1. K₀=GF(p), where p=2^{31-1:}

The K₀-adder, multiplier can be implemented on 32-bit CPUs using the instructions for integer arithmetic. The K₀-inverter can be implemented using binary extended Euclid division as follows.

Inversion in GF(2³¹)

Input: integer 0<a<p=2³¹−1.

Output: integer b=a⁻¹modp.

```
Begin: integer a₀ = p; a₁ = a; u = 0; v = 1; k = 0;
if a₁ is even, do
    {a₁ = p − a₁; v = −1;}
while a₁ > 1, do {
    a₀ = a₀ − a₁; u = u − v; k = k + 1;
        while a₀ is even, do
        {a₀ = a₀/2; v = 2v; k = k + 1;}
    if a₀ < a₁, swap (a₀, a₁), swap (u, v);
}
b = v × 2^{31-k} mod p.
End
```

Define K₁ to be the extension of K₀ with irreducible polynomial X³−7, and K₂ over K₁ is defined by X²+1. Elements of K₁ are represented by 3-tuples (a₀, a₁, a₂), and Elements of K₂ are represented by 6-tuples (α₀, α₁)=(a₀, a₁, a₂, a₃, a₄, a₅) where the first half and last half can be regarded as elements in K₁. The multiplier and inverter of K₁ are described as follows, where all +; x are in GF(p).

Multiplication in K₁=GF(2³¹−1)³

Input: a=(a₀,a₁,a₂;b=(b₀,b₁,b₂)εK₁.

Output: c=(c₀,c₁,c₂)=ab.

Begin

m₀=(a₀+a₁)(b₀+b₁);m₁=(a₁+a₂)(b₁+b₂);m₂=(a₀+a₂)(b₀+b₂);m₃=a₀b₀;m₄=a₁b₁;m₅=a₂b₂;

c₀=m₃+7(m₁−m₄−m₅);c₁=m₀−m₃−m₄+7m₅;c₂=m₂+m₄−m₃−m₅;

End

Inversion in K₁=GF(2³¹−1)³

Input: a=(a₀,a₁,a₂)εK₁.

Output: b=(b₀,b₁,b₂)=a⁻¹.

```
Begin
            r = a²₀ − 7a₁a₂;
if r = 0{
        s = 7(a₀a₂ − a₁² )⁻¹; b₀ = 0; b₁ = sa₀; b₂ = −sa₁;
    }
else {
    s = a₁(a₀ − a₂); t = a₂(a₀ − 7a₁); u = (−ra₀ + 7sa₂ + 7ta₁)⁻¹;
                b₀ = −ur; b₁ = us; b₂ = ut;
    }
End
```

The multiplier and inverter of K₂ are formulated in the following.

Multiplication in K₂=(GF(2³¹−1)³)²

Input: (α₀,α₁),(β₀,β₁)εK₂.

Output: (α,β)=(α₀,α₁)(β₀,β₁).

Begin

α=α₀β₀−α₁β₁;

β=(α₀+α₁)(β₀+β₁)−α₀β₀−α₁β¹;

End

Inversion in K₂=(GF(2³¹−1)³)²

Input: (α₀α₁)εK₂.

Output: (β₀β₁)=(α₀,α₁)⁻¹.

Begin

α=(α₀²+α₁²)⁻¹;

β₀=αα₀;β₁=αα₁;

End

One ECC reported in D. V. Bailey and C. Parr's paper referred to above uses OEF K₀⁽⁶⁾ with K₀=GF(2³¹−1). The cost ratio of field multiplication/inversion with this method is about 1/5. Compared to this, the above construction gives a ratio about 1/2:5, and hence improves the ECC performance by at least 25%.

2. K₀=GF(2⁷):

The operations in K₀ can be implemented on 8-bit processors as follows. The elements of K₀ are represented by integers in the range [0, 127]. Choose a primitive element g of K₀. Make a powers-table exp [i]=gⁱ0≦i≦126 and make a logarithms-table log [a]=log_{g}^{a}1≦a≦127. The multiplication in K₀ can be implemented as

ab=exp [ log [a]+log [b]mod127]a≠0;b≠0:

The inversion can be implemented as

a⁻¹=exp [127−log [a]]a≧2:

There are 4 extension steps to get the final 168-bit field K₄. K₁/K₀ has degree 3 and Kᵢ/Kᵢ₋₁; 1<I≦4 are quadratic. The irreducible polynomials and implementation of the operations in K, can follow the process described in the previous section.

Compared with the “sub-field method” with the same K₀, this construction improves the multiplication/inversion cost ratio from about 1/8 to 1/1:5, and thus improves the ECC speed by about 2:5 times.

3. K₀=GF(2³¹):

In this case, the K₀-multiplier and inverter are best suited for hardware implementation. The irreducible polynomials for K₁; K₂ are X³+X+1 and X²+X+1 respectively. The implementation of operations in K₂ are described in the previous section. Compared with the “sub-field method”, this improves the multiplication/inversion cost ratio from about 1/5 to 1/1:5, and thus improves the ECC speed by about 1:8 times.

Therefore, in summary, in a preferred embodiment of the present invention, the construction of the finite field consists of devices to perform operations in a small base field K₀ and methods for successive field extensions. The first extension step K₁/K₀ may have degree 2 or 3 according to size k₀ of K₀ and the security parameter or key k. Subsequent extensions should all be quadratic. For a degree 3 extension K₁/K₀, one multiplication in K₁ needs 6 multiplications in K₀, while one inversion in K, needs no more than 12 multiplications and one inversion in K₀. For a quadratic extension K₁/Kᵢ₋₁, one multiplication in Kᵢ needs 3 multiplications in Kᵢ₋₁, and one inversion in Kᵢ needs 3 or 4 (according to the characteristic being even or odd) multiplications in Kᵢ₋₁ and one inversion in Kᵢ₋₁. Thus both multiplication and inversion in the final field can be implemented very efficiently via the devices to perform operations in the base field K₀.

On desktop computers, the best choice for K₀ is GF(p) as in OEFs. In this case, the present invention maintains all advantages of OEFs and improves the inversion operation efficiency significantly.

On 8-bit general purpose microprocessors, K₀ may be chosen as GF(2⁷), and the multiplication and inversion in this base field can be implemented via table look-up.

For hardware implementation, only operations in K₀ need be circuit integrated, the rest can be implemented via simple programming logic and thus greatly reduce the size and cost of the hardware. In this case, K₀ can be chosen as GF(2ⁿ) where n is selected according to cost-effectiveness requirement of the application context.

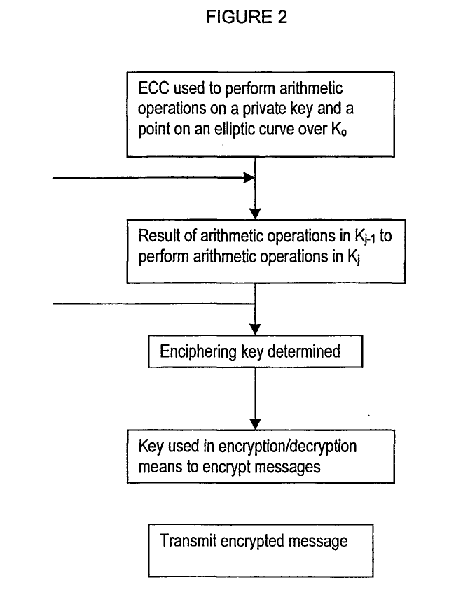

The invention may be used in a method for encrypting/decrypting a message for transmission, as indicated in FIG. 2.

Variations and additions are possible within the general inventive concept as will be apparent to those skilled in the art.

The claims defining the invention are as follows:

1. In an electronic information encryption/decryption system, a method of implementing elliptic curve cryptography including:
performing arithmetic operations over a base field Kₒ; and
undertaking arithmetic operations in one or more extension fields Kⱼ, based upon the operations in the previous field Kⱼ₋₁.

2. Method of claim 1 wherein Kₒ is GF(p) where p is a prime number of the form p=2ⁿ±c and where c<2^{n/2} is a small integer.

3. Method of claim 1 where K₀ is GF(2ⁿ), the characteristic is 2, the extension degree is 2 and the one or more subsequent extensions and further including the steps of:
selecting irreducible polynomials for each extension step, such that:
if n is odd Pₒ(X)=x²+X+1 is an irreducible polynomial in the first extension step K₁/Kₒ; or
if n=2^{k}n′ with n′ odd Pₒ(X)=X²+yₒX+1 is an irreducible polynomial in the first extension step K₁/Kₒ; and
for all subsequent extension steps x; is a root of Pⱼ₋₁(X) in Kⱼ, so that Pⱼ(X)=X²+xⱼX+1 is irreducible over Kⱼ and defines the extension Kⱼ₋₁/Kⱼ

4. Method of claim 3 further including the step of performing a plurality of operations in Kⱼ, on an element a+bxⱼE Kⱼ denoted (a,b), wherein the operations may be from the group comprising:
Multiplication by xⱼ:(a,b)xⱼ=(b,a+bxⱼ₋₁);
Squaring: (a,b)²=((a+b)²,b²xⱼ₋₁);
Multiplication: (a,b)(c,d)=(ac+bd,ad+bc+bdₓ₋₁); and
Inversion: (a,b)⁻¹⁼⁽a²+b²+abxⱼ₋₁)⁻¹(a+bxⱼ₋₁,b).

5. Method of claim 1 or 2 where K₀ is GF(p), the characteristic is odd, the security parameter is k, m is the smallest positive integer of the form 3×2^{j-1} or 2^{j} such that m×kₒ>k and further including the steps of:
ascertaining whether a binomial irreducible polynomial of the form X^{m}−w exists, such that P₀(X)=X²−w or P₀(X)=X³−w and Pᵢ(X)=X²−x_{I} for all subsequent steps, where x_{I} is a solution of the previous P_{I-1}, in K_{I} and wherein such an irreducible polynomial will exist if one of the following conditions is met:
(a) 3|m and j=2, then 3|p−1;
(b) 3|m and j>2, then 12|p−1;
(c) 3|m and; j<2, then 4|p−1.
If a condition is satisfied, and such an irreducible polynomial exists, w is the primitive root of p;
If such an irreducible polynomial does not exists, choosing an irreducible polynomial according to the following criteria:
(d) if 3|m, then P₀(X) may be any irreducible polynomial of degree 3 with simple coefficients;
(e) if 3|p−1, then P₀(X)=X³−w or P₀(X)=X³−X−w such that w E GF(p) with lowest hamming weight required for P₀(X) to be irreducible;
(f) if p=3 mod4 and m=2^{j}, P_{O}(X)=X²+1 and xᵢ=x₀+w E K such that P₁(X)=X²−xᵢ is irreducible, where x₀ is a quadratic non-residue with lowest hamming weight;
(g) if p=I mod 4 and m=2^{j}, P₀(X)=X²−w and P₁(X)=X²−xᵢ, where xᵢ is a solution of Pᵢ₋₁ and w E GF(p) and has lowest hamming weight.

6. Method of claim 8 wherein n=7 and the arithmetic operations are performed via table lookup.

7. Method of claim 8 wherein arithmetic operations in Kₒ are circuit integrated and all sub-field operations are implemented via programming logic.

8. Method of claim 11 performed on an 8 bit microprocessor.

9. Method of electronically converting an electronic message to an encrypted message for transmission over a transmission medium, said method comprising the steps of:
using an ECC to perform arithmetic operations on a private key and a point, wherein said point is a point on an elliptic curve over a finite field Kₒ; and
undertaking arithmetic operations in one or more extension fields Kⱼ, based upon the operations in the previous field Kⱼ₋₁, in order to determine an enciphering key;
using an encryption/decryption means to convert said electronic message to said encrypted message using said enciphering key; and
using a transmitting means to transmit said encrypted message over said transmission medium.

10. Computer program product including a computer usable medium having computer readable program code and computer readable system code embodied on said medium for implementing elliptic curve cryptography within a data processing system, said computer program product further including computer readable code within said computer usable medium for:
constructing a finite field Kₒ, such that the size of the field exceeds a security parameter k; and
performing arithmetic operations in Kₒ and in at least one subsequent extension field Kⱼ, based upon the operations in the previous field Kⱼ₋₁.

11. Function module for performing large finite field operations comprising of:
(a) a plurality of devices for carrying out arithmetic operations in a field Kₒ, being from the following group:
i) One or more K₀-adders for performing additions and/or subtractions in K₀.
ii) One or more K₀-multipliers for performing multiplications in K₀.
iii) One or more K₀-inverters for performing inversions in K₀.
b) Logic means for utilizing the devices in (a) to iteratively form one or more multipliers and/or inverters in one or more extension fields K, in order to carry out arithmetic operations in the one or more extension fields.

12. Function module of claim 11 wherein at least one of the one or more K₀ multipliers are devices for performing special type multiplications in K₀.

13. Function module of claim 11 wherein the one or more extension fields are of degree 2 or 3.

14. Function module of claim 11 wherein Kₒ is GF(p) where p is a prime number of the form p=2ⁿ±c and where c<2^{n/2} is a small integer.
